(19) United States
(12) Patent Application Publication
(10) Pub. No.: US 2010/0294534 A1
(43) Pub. Date: Nov. 25, 2010

(54) CONDUCTOR WIRE FOR ELECTRONIC APPARATUS AND ELECTRICAL WIRE FOR WIRING USING THE SAME

(75) Inventors: Kuniteru Mihara, Tokyo (JP); Isao Takahashi, Tokyo (JP)

Correspondence Address: BIRCH STEWART KOLASCH & BIRCH, PO BOX 747, FALLS CHURCH, VA, 22040-0747, US

(73) Assignee: The Furukawa Electric Co., Ltd., Tokyo (JP)

(21) Appl. No.: 12/740,955

(22) PCT Filed: Oct. 30, 2008
(86) PCT No.: PCT/JP2008/069760

§ 371 Date: Jul. 30, 2010

(30) Foreign Application Priority Data
Nov. 1, 2007 (JP) 2007-285585

(51) Int. Cl. H01B 5/00

(52) U.S. Cl. 174/126.1

(57) ABSTRACT

Disclosed herein is a conductor wire for electronic device, which has high strength and excellent electrical conductivity and is composed of a copper alloy containing 0.5-3.0 mass percent, 0.1-1.0 mass percent of silicon, and the balance being copper and inevitable impurities. The copper alloy may further contain 0.1-3.0 mass percent of nickel and may further contain the sum total of 0.05-1.0 mass percent of one or two or more elements selected from the group consisting of iron, silver, chromium, zirconium and titanium. The copper alloy may also contain the sum total of 0.01-3.0 mass percent of one or two or more elements selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

### TECHNICAL FIELD

The present invention relates to a conductor wire for electronic apparatus, and to an electrical wire for wiring using the same.

### BACKGROUND ART

In the prior art, as wires for electronic apparatus, wires for automotive wiring or wires for robot, electrical wires which are composed of either a twisted-pair copper wire provided in JISC3102 or a tin-plated, twisted-pair copper wire and an insulation material (such as vinyl chloride or crosslinked polyethylene) concentrically covering the twisted-pair copper wire have been mainly used.

In some electronic apparatus, wires which are fitted with connectors (females) in an uncovered state are also used. Because the above-mentioned twisted-pair copper wires do not have sufficient strength, alloy wires having reduced electrical conductivity compared to that pure copper, for example, brass (JIS-C2700W), phosphor bronze (C5191W), iron-containing copper (JIS-C1940W), a Cu—Ni—Si alloy (C7025W) or a beryllium-copper alloy (C1720W), have been used. Moreover, various control circuits which are mounted in automobiles have increased in recent years, and the number of wirings therein is being increased. Particularly, the ratio of signal current circuits for control in automotive wiring circuits is being increased. For this reason, with the increase in the weight of electrical wires, the requirement for reliability for durability and long-term electric current conduction in, for example, the connections of electrical wires, is being increased. Under such circumstances, it has been required to ensure the above-mentioned reliability while reducing the weight of electrical wires in terms of energy saving.

For use in electronic apparatus, a material having higher electrical conductivity is preferable, because the frequency of electric current used becomes higher every year. Also, in view of the requirement for lightweight and reliability, a high-strength material resistant to high voltage is required.

Meanwhile, high electrical conductivity is required because of problems associated with the generation of heat in a fitting portion. Electrical wires and conductors serve to carry electricity and to dissipate heat generated in a fitting portion (see, for example, Non-Patent Reference 1). Namely, they play a role in dissipating heat through conductor portions, and thus play a great role in suppressing deterioration resulting from combustion or heat generation.

Although prior electrical wire conductors made of pure copper had a sufficient electric current conducting capacity, it was difficult to reduce the diameter of the wires, because the mechanical strength of the wire conductors themselves and the crimp terminals thereof was low. Meanwhile, in the case of alloy wires, sufficient strength could be obtained, but low electrical conductivity was pointed out as a problem. With respect to the manufacture of alloy wires, there were attempts to increase the strength of the wires and thin the wires (see, for example, Patent Reference 1). Furthermore, there were attempts to twist a plurality of copper alloy wires and hard copper wires together so as to prevent them from twisting about each other and improve the mechanical and electrical properties thereof (see, for example, Patent Reference 2). However, these attempts have a disadvantage in that either connections between electrical wires or solder connections used as a lead wires are likely to be detached. In addition, materials having the desired strength and electrical conductivity cannot be obtained from alloy wires disclosed in Patent References 3 and 4. Furthermore, low-priced materials must be provided for general purpose use. The use of a specific vacuum melting furnace or powder metallurgy leads to an increase in production cost (see, for example, Patent Reference 5).

### [Non-Patent Reference 1] Furukawa Electric Review No. 81, p. 123

### [Patent Reference 1] Japanese Patent Laid-Open Publication No. 1994-60722

### [Patent Reference 2] Japanese Patent Laid-Open Publication No. 1999-224538

### [Patent Reference 3] Japanese Patent Laid-Open Publication No. 2001-316741

### [Patent Reference 4] Japanese Patent Laid-Open Publication No. 2007-157509

### [Patent Reference 5] Japanese Patent Laid-Open Publication No. 1998-140267

### DISCLOSURE OF THE INVENTION

The present inventors have made many efforts and, as a result, have found that a high-strength and high-electrical-conductivity material can be prepared using a copper alloy having a specific composition. On the basis of this fact, the present invention has been made.

Specifically, the present invention provides the following conductor wire for electronic apparatus and the following electrical wire for wiring.

(1) A conductor wire for electronic apparatus composed of a copper alloy which contains 0.5-3.0 mass percent of cobalt, 0.1-1.0 mass percent of silicon, and the balance being copper and inevitable impurities.

(2) The conductor wire for electronic apparatus as set forth in paragraph (1), wherein the copper alloy further contains 0.1-3.0 mass percent of nickel.

(3) The conductor wire for electronic apparatus as set forth in paragraph (1) or (2), wherein the copper alloy further contains the sum total of 0.05-1.0 mass percent of one or two or more elements selected from the group consisting of iron, silver, chromium, zirconium and titanium.

(4) The conductor wire for electronic apparatus as set forth in any one of paragraphs (1) to (3), wherein the copper alloy further contains the sum total of 0.01-3.0 mass percent of one or two or more elements selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

(5) The conductor wire for electronic apparatus as set forth in any one of paragraphs (1) to (4), wherein the total cold-working ratio before and after aging heat treatment is more than 99%.

(6) An electrical wire for wiring composed of a plurality of conductor wires for electronic apparatus as set forth in any one of paragraphs (1) to (5), the conductor wires being twisted together.

The above-mentioned and the other characteristics and also advantage of this invention will become clearer from the following.

### BEST MODE FOR CARRYING OUT THE INVENTION

Hereinafter, the inventive conductor wire for electronic apparatus will be described in detail.

First, the elements and composition of the copper (Cu) alloy that is used in the inventive conductor wire for electronic apparatus will be described in detail together with the operation and effect thereof.

Cobalt (Co) and silicon (Si) are elements that can improve the strength of the copper alloy when they are added, because they can Co—Si precipitates (CoSi, Co₂Si and CoSi₂) in a matrix by controlling the ratio of the contents thereof, thus achieving precipitation hardening.

The content of cobalt is 0.5-3.0 mass percent, and preferably 1.0-2.0 mass percent. If the content of cobalt is too low, the precipitation hardening effect thereof will be small, and thus the resulting copper alloy will have insufficient strength. If the content of cobalt is too high, the effect thereof will be saturated.

It is known that silicon has an increased strengthening effect, when the content thereof is about 1½ of the content of cobalt as calculated in mass percent. Based on this fact, in the inventive conductor wire for electronic apparatus, the content of silicon is 0.1-1.0 mass percent, and preferably 0.3-0.8 mass percent.

Nickel (Ni) forms precipitates (Ni—Si and Ni₂Si) with silicon as cobalt does. Also, nickel is partially substituted by cobalt to produce ternary compounds (Ni—Co—Si) which can all improve the strength of the copper alloy. If nickel is contained in the copper alloy, the content thereof in the alloy is preferably 0.1-3.0 mass percent, and more preferably 0.5-1.5 mass percent. If the content of nickel is too low, there will be some cases in which the precipitation hardening effect thereof is small and the resulting copper alloy has insufficient strength. If the content of nickel is too high, the effect thereof will be saturated. An excessive content of nickel will be dissolved in the parent metal of copper, thus reducing electrical conductivity.

Iron (Fe), silver (Ag), chromium (Cr), zirconium (Zr) and titanium (Ti) are all elements that precipitate in the parent metal of copper to strengthen the parent metal. If these elements are contained in the copper alloy, the sum total of the contents thereof is preferably 0.05-1.0 mass percent, and more preferably 0.1-0.5 mass percent. If the contents of these elements are too low, sufficient hardening cannot sometimes be achieved, and if the contents are too high, they will reduce processability (splitting, wire breaking, etc.).

Magnesium (Mg), zinc (Zn), tin (Sn), manganese (Mn) and aluminum (Al) are all elements that are solid-dissolved in the parent metal of copper and exhibit solution strengthening. The addition of these elements strengthens the copper alloy, but if the content thereof is too high, it will reduce electrical conductivity.

If magnesium is contained in the copper alloy, the content thereof is preferably 0.05-0.5 mass percent, and more preferably 0.1-0.5 mass percent.

If zinc is contained in the copper alloy, the content thereof is preferably 0.1-2.5 mass percent, and more preferably 0.3-1.0 mass percent.

If tin is contained in the copper alloy, the content thereof is preferably 0.1-2.0 mass percent, and preferably 0.2-1.0 mass percent.

If manganese is contained in the copper alloy, the content thereof is preferably 0.01-0.5 mass percent, and more preferably 0.05-0.2 mass percent.

If aluminum is contained in the copper alloy, the content thereof is preferably 0.01-0.5 mass percent, and more preferably 0.05-0.2 mass percent.

If these elements are contained in the copper alloy, the sum total of the contents thereof is preferably 0.01-3.0 mass percent, and more preferably 0.05-1.0 mass percent.

The copper alloy that is used in the inventive conductor wire for electrical/electronic apparatus may be prepared according to a conventional method. For example, the copper alloy may be prepared in the following manner. Namely, a cast billet is prepared by melting a blend of desired metal elements. In the cast billet, coarse and large grains (all ≧1 μm) formed during the melting and casting processes exist. To solid-dissolve such grains, the cast billet is subjected to homogenizing heat-treatment at 800-1000° C. for 0.1-2 hours. After the heat treatment, the billet is subjected to hot extrusion or hot rolling, and then immediately, is quenched. By doing so, it is possible to make grains fine and to provide a hot-worked material in which the formation of coarse and large precipitates has been inhibited. It is preferable to subject the hot-extruded alloy to water quenching immediately after the hot extrusion. Moreover, methods (e.g., the SCR method) in which the cast billet is hot-worked after the casting process may also be applied in the present invention.

By doing so, the billet may be prepared into, for example, a round rod, and the rod may be drawn to a given thickness, thus producing a conductor wire. However, the scope of the present invention is not limited only to the wire drawing of a round rod, and the conductor wire of the present invention may be formed to have a desired size and shape depending on the intended use thereof.

To obtain a high-strength and high-electrical-conductivity material, a strengthening mechanism which employs precipitation hardening and work hardening is generally used.

In the alloy that is used in the present invention, the total cold working ratio before and after precipitation heat treatment (so-called aging heat treatment) is preferably more than 99%, and more preferably 99.5-99.9%. This enables a high-strength and high-electrical-conductivity conductor wire for electrical devices to be obtained. The term “cold working” refers to a method of working a material without heating and does not include the above-described hot working (extrusion). In the present invention, the aging heat treatment of the alloy is preferably carried out at 300-600° C. for 0.5-4 hours. In addition, if the cold working ratio before aging heat treatment is ≦50%, the aging heat treatment temperature is preferably 500-600° C., and if the cold working ratio before aging heat treatment is ≦90%, the aging heat treatment temperature is preferably 400-500° C. If the cold working ratio before aging heat treatment is >90%, the aging heat treatment temperature is preferably 300-450° C. However, in any case, when the total cold working ratio before and after aging heat treatment (that is, working ratio during a period ranging from hot rolling to the completion of a product) is ≧99%, a material having a good balance of strength and electrical conductivity can be obtained. Also, when aging heat treatment is carried out in several steps, electrical conductivity properties will further be improved. For example, the material after hot rolling is heated-treated at 550° C. for 2 hours, cold-worked to 90% reduction in thickness, heat-treated at 400° C. for 1 hour, and then cold-worked again to 90% reduction in thickness, thus obtaining a material having a total cold working ratio (working ratio during a period ranging from hot rolling to the completion of a product) of 99%. This material has electrical conductivity higher than that of a material obtained by performing aging heat treatment once.

As used herein, The “working rate” is the percentage that divided it in the cross-section area of before where processes the difference in the cross-section area after the cross-section area and processing of the material before processing.

Next, we explain it about the electric wire for the wiring of this invention.

The inventive electrical wire for wiring may be a twisted-pair wire formed by twisting a plurality (preferably 3-20) of conductor wires together. There is no particular limitation on the shape and size of the inventive electrical wire for wiring, and the inventive electrical wire for wiring may be processed into a desired shape and size depending on the intended use thereof and may be covered with an insulation material. In addition, the inventive electrical wire for wiring may be further compressed, and then, subjected to aging annealing, for example, at 300-550° C. for 1-5 hours.

As described above, the conductor for electrical/electronic apparatus which is used in the present invention is prepared by adding given amounts of various required elements to a Cu—Co—Si alloy. This conductor can be suitably used for high-strength and high-electrical-conductivity wires for electronic/electrical devices, and electrical wires for wiring, as well as male terminals, pins, automotive wire harnesses, etc.

The inventive conductor wire for electronic apparatus is a high-strength and high-electrical-conductivity wire having a tensile strength (TS) of more than 600 MPa and an electrical conductivity of more than 40% IACS and can be manufactured at a low cost, because it does not require a special melting method or stretching method.

In addition, the inventive conductor wire for electronic apparatus has excellent strength and electrical conductivity, and thus can be suitably used for electrical/electronic apparatus and electrical wires for wiring which requires high strength and high electrical conductivity.

Furthermore, according to the present invention, in case that a conductive wire is allowed to be stretched due to an inflicted shock load, a conductive wire having an elongation (i.e., stretch) of more than 5%, tensile strength (TS) of more than 400 MPa, and an electrical conductivity of more than 40% IACS can be obtained by applying an aging heat treatment after cold working into a desired size. In particular, when a plurality of conductive wires of the invention are twisted, then compressed and subjected to an aging heat treatment, an electrical wire for wiring having a high elongation (i.e., stretch) value used for an automobile, robot wiring or the like can be obtained. The aging heat treatment in the working into the conductive wire, a total cold working rate in the cold working before and/or after the aging heat treatment and the aging heat treatment applied after twisting a plurality of conductor wires are preferably applied under the preferable respective conditions described above.

### EXAMPLES

Hereinafter, the present invention will be described in further detail with reference to examples, but the scope of the present invention is not limited to these examples.

### Example 1

According to the alloy composition shown in Tables 1 and 2 below, metal materials were melted in a high-frequency melting furnace and an atmosphere melting furnace, thus casting a billet. The billet was subjected to homogenizing heat-treatment at 900° C. for 1 hour, hot-extruded, and then immediately, quenched in water, thus obtaining a round rod (diameter of 20 mm). Then, the round rod was cold-drawn into wires having various diameters. The wires were heat-treated in various heat-treatment conditions, and then cold-drawn. If necessary, specimens manufactured by repeating the aging heat treatment process and the cold wiring process were also prepared.

Meanwhile, in the present invention, alloys having compositions within the specified range are shown in inventive examples, and alloys having compositions out of the specified range are shown in comparative examples.

For each of the electrical wire specimens thus obtained,

[1] tensile strength and [2] electrical conductivity were measured in the following manner. The measurement of each item is as follows.

### [1] Tensile Strength (TS)

Three specimens of each electrical wire were measured in accordance with JIS Z 2241, and the average (MPa) of the measurements is shown in Tables 3 and 4 below.

### [2] Electrical Conductivity (EC)

Two specimens of each electrical wire were measured for electrical conductivity using a four-probe method in a thermostat controlled at 20° C.±1° C., and the average (% IACS) of the measurements is shown in Tables 3 and 4. Herein, the distance between terminals was 100 mm.

Material Nos. 1-30 shown in Table 1 are inventive examples having the alloy compositions of the present invention, and materials No. 101-118 shown in Table 2 are comparative examples.

Material Nos. 101, 102 and 113 to 116 in Table 2 are comparative example for the invention related to the item (1) above (material Nos. 1 to 5 of the example of the invention). Material No. 103 is a comparative example for the invention related to the item (2) above (material Nos. 6 to 8 of the example of the invention). Material Nos. 104 to 107 are comparative examples for the invention related to the item (3) above (material Nos. 9 to 13 and 23 of the example of the invention). Material Nos. 108 to 112, 117 and 118 are comparative example for the invention related to the tem (4) above (material Nos. 14 to 18, 20 to 22 and 24 to 30 of the example of the invention).

In Tables 1 and 2, numerical values are expressed as mass percent, and the balance is copper and inevitable impurities.

TABLE 1

| No. | Co | Si | Ni | Fe | Ag | Cr | Zr | Ti | Extra |
|---|---|---|---|---|---|---|---|---|---|
| 1 | 0.6 | 0.15 | | | | | | | |
| 2 | 1.1 | 0.35 | | | | | | | |
| 3 | 1.45 | 0.67 | | | | | | | |
| 4 | 2.3 | 0.84 | | | | | | | |
| 5 | 2.75 | 0.93 | | | | | | | |
| 6 | 1 | 0.6 | 1.5 | | | | | | |
| 7 | 0.5 | 0.5 | 2 | | | | | | |
| 8 | 1.5 | 0.77 | 0.25 | | | | | | |
| 9 | 1.4 | 0.45 | | 0.3 | | | | | |
| 10 | 1.4 | 0.44 | | | 0.1 | | | | |
| 11 | 1.4 | 0.44 | | | | 0.25 | | | |
| 12 | 1.55 | 0.54 | | | | | 0.43 | | |
| 13 | 1.34 | 0.41 | | | | | | 0.2 | |
| 14 | 1.2 | 0.33 | | | | | | | Mg = 0.2 |
| 15 | 1.3 | 0.35 | | | | | | | Zn = 0.3 |
| 16 | 1.2 | 0.4 | | | | | | | Sn = 0.15 |
| 17 | 1.4 | 0.24 | | | | | | | Mn = 0.05 |
| 18 | 1.3 | 0.28 | | | | | | | Al = 0.03 |
| 19 | 1.4 | 0.34 | | | | 0.2 | 0.1 | | |
| 20 | 1.5 | 0.45 | | | | 0.15 | | | Mg = 0.15, Sn = 0.1 |
| 21 | 1.6 | 0.58 | | | | | | | Sn = 0.2, Zn = 0.2 |
| 22 | 1.3 | 0.4 | 1.4 | | | | | | Mn = 0.06 |
| 23 | 1.1 | 0.38 | | 0.12 | | | | | |
| 24 | 0.9 | 0.28 | | | | | 0.11 | | Mg = 0.2, Sn = 0.1, Zn = 0.2 |
| 25 | 0.55 | 0.19 | | | | 0.15 | | | Mg = 0.1 |
| 26 | 0.69 | 0.4 | 0.5 | | | 0.1 | | | Sn = 0.11, Zn = 0.4 |
| 27 | 0.84 | 0.45 | 0.45 | 0.15 | | 0.1 | | | Zn = 0.5 |
| 28 | 0.5 | 0.6 | 1.5 | | | 0.2 | | | Mg = 0.2, Sn = 0.15, Zn = 0.5 |
| 29 | 0.6 | 0.44 | 1.1 | | | | | | Sn = 0.11, Zn = 0.4 |
| 30 | 0.9 | 0.47 | 1.2 | | | | | | Mg = 0.15, Sn = 0.15, Zn = 0.55 |

TABLE 2

| No. | Co | Si | Ni | Fe | Ag | Cr | Zr | Ti | Extra |
|---|---|---|---|---|---|---|---|---|---|
| 101 | 0.3 | 0.3 | | | | | | | |
| 102 | 3.3 | 0.4 | | | | | | | |
| 103 | 0.7 | 0.4 | 3.5 | | | | | | |
| 104 | 1.5 | 0.4 | | 0.03 | | | | | |
| 105 | 1.55 | 0.45 | | | | 1.3 | | | |
| 106 | 1.52 | 0.41 | | | | | 1.2 | | |
| 107 | 1.44 | 0.39 | | | | | | 1.5 | |
| 108 | 1.5 | 0.39 | | | | | | | Mg = 0.03 |
| 109 | 1.7 | 0.4 | | | | | | | Mg = 1.7 |
| 110 | 1.6 | 0.38 | | | | | | | Mn = 1.8 |
| 111 | 1.44 | 0.34 | | | | | | | Sn = 2.2 |
| 112 | 1.34 | 0.39 | | | | | | | Zn = 3.0, Sn = 1.1 |
| 113 | 0.5 | 0.07 | | | | | | | |
| 114 | 0.9 | 1.22 | | | | | | | |
| 115 | 2.1 | 0.08 | | | | | | | |
| 116 | 2.2 | 1.19 | | | | | | | |
| 117 | 1.2 | 0.34 | | | | | | | Mg = 0.2, Sn = 1.8, Zn = 1.1, Mn = 0.3 |
| 118 | 1.1 | 0.6 | 1.5 | | | | | | Mg = 0.3, Sn = 1.6, Zn = 1.8, Mn = 0.2 |

Tables 3 and 4 show the properties (tensile strength and electrical conductivity) of materials obtained under varying combinations of aging heat treatment and cold working ratio. Meanwhile, Table 3 shows inventive examples, and Table 4 shows comparative examples.

Process (1): cold working (working ratio=90%)-aging heat treatment (at 440° C. for 2 hours)-cold working (working ratio=90%) [total working ratio=99%]

Process (2): aging heat treatment (at 550° C. for 2 hours)-cold working (working ratio=99%)

Process (3): cold working (working ratio=75%)-aging heat treatment (at 490° C. for 2 hours)-cold working (working ratio=50%)-aging heat treatment (at 500° C. for 2 hours)-cold working (working ratio=90%) [total working ratio=99%]

TABLE 3

| | | |
|---|---|---|
| Process(1) | Process(2) | Process(3) |

| No. | TS | EC | TS | EC | TS | EC |
|---|---|---|---|---|---|---|
| 1 | 663 | 70 | 736 | 61 | 668 | 72 |
| 2 | 741 | 69 | 772 | 62 | 744 | 71 |
| 3 | 791 | 68 | 836 | 67 | 794 | 70 |
| 4 | 924 | 65 | 932 | 64 | 929 | 67 |
| 5 | 1104 | 62 | 1163 | 60 | 1114 | 64 |
| 6 | 1005 | 48 | 1068 | 40 | 1010 | 49 |
| 7 | 1006 | 49 | 1010 | 45 | 1013 | 52 |
| 8 | 703 | 62 | 749 | 52 | 710 | 65 |
| 9 | 684 | 68 | 728 | 58 | 693 | 70 |
| 10 | 684 | 68 | 693 | 57 | 687 | 69 |
| 11 | 685 | 68 | 699 | 60 | 687 | 71 |
| 12 | 624 | 68 | 686 | 65 | 633 | 70 |
| 13 | 660 | 68 | 683 | 65 | 670 | 71 |
| 14 | 685 | 69 | 753 | 62 | 688 | 70 |
| 15 | 644 | 68 | 725 | 59 | 652 | 71 |
| 16 | 684 | 66 | 710 | 60 | 693 | 68 |
| 17 | 686 | 67 | 727 | 61 | 695 | 69 |
| 18 | 645 | 68 | 673 | 62 | 646 | 72 |
| 19 | 645 | 68 | 698 | 66 | 702 | 70 |
| 20 | 604 | 65 | 618 | 55 | 614 | 68 |
| 21 | 643 | 64 | 666 | 59 | 644 | 66 |
| 22 | 1088 | 58 | 1168 | 53 | 1090 | 60 |
| 23 | 625 | 69 | 664 | 65 | 635 | 71 |
| 24 | 764 | 55 | 829 | 51 | 769 | 57 |
| 25 | 624 | 70 | 711 | 60 | 626 | 74 |
| 26 | 680 | 48 | 697 | 45 | 685 | 51 |
| 27 | 640 | 60 | 657 | 57 | 644 | 62 |
| 28 | 804 | 41 | 874 | 40 | 813 | 43 |
| 29 | 685 | 42 | 727 | 36 | 690 | 44 |
| 30 | 845 | 44 | 858 | 35 | 850 | 46 |

TABLE 4

| | Process(1) | | Process(2) | | Process(3) | |
|---|---|---|---|---|---|---|
| No. | TS | EC | TS | EC | TS | EC |
| 101 | 322 | 70 | 366 | 67 | 330 | 73 |
| 102 | 1029 | 39 | 1052 | 34 | 1039 | 42 |
| 103 | 1092 | 38 | 1189 | 36 | 1097 | 40 |
| 104 | 505 | 68 | 506 | 59 | 510 | 69 |
| 105 | wire breaking | | wire breaking | | wire breaking | |
| 106 | wire breaking | | wire breaking | | wire breaking | |
| 107 | wire breaking | | wire breaking | | wire breaking | |
| 108 | 555 | 68 | 573 | 59 | 561 | 71 |
| 109 | wire breaking | | wire breaking | | wire breaking | |
| 110 | 645 | 27 | 715 | 26 | 653 | 30 |
| 111 | 582 | 33 | 641 | 26 | 584 | 35 |
| 112 | 498 | 40 | 583 | 32 | 506 | 42 |
| 113 | 208 | 70 | 214 | 66 | 209 | 73 |
| 114 | 361 | 44 | 368 | 36 | 369 | 48 |
| 115 | 867 | 35 | 875 | 33 | 876 | 36 |
| 116 | 883 | 36 | 896 | 36 | 885 | 39 |
| 117 | 485 | 36 | 529 | 27 | 492 | 37 |
| 118 | 1045 | 37 | 1068 | 33 | 1052 | 39 |

As can be seen in Table 3, inventive example Nos. 1-30 had excellent properties of tensile strength of more than 600 MPa and electrical conductivity of more than 40% IACS for the wires prepared by at least one process of processes (1) to (3). Particularly, the wires treated by process (3) showed higher electrical conductivity compared to the wires prepared by process (1) or (2).

In comparison with this, as shown in Table 4, comparative example Nos. 101 to 118 showed a tensile strength of less than 600 MPa, an electrical conductivity of less than 40% IACS or wire breaking even for the wires prepared by any process of processes (1) to (3).

Table 5 below shows other examples of the present invention. Namely, Table 5 shows the properties (tensile strength and electrical conductivity) materials obtained under varying combinations of aging heat treatment and cold working ratio.

Process (4): cold working (working ratio=50%)-aging heat treatment (at 500° C. for 2 hours)-cold working (working ratio=50%) [total working ratio=75%]

Process (5): cold working (working ratio=99%) [total working ratio=99%]; having no heat treatment.

TABLE 5

| | |
|---|---|
| Process(4) | Process(5) |

| No. | TS | EC | TS | EC |
|---|---|---|---|---|
| 1 | 534 | 74 | 800 | 33 |
| 2 | 599 | 78 | 885 | 32 |
| 3 | 632 | 77 | 949 | 32 |
| 4 | 741 | 70 | 1110 | 30 |
| 5 | 889 | 67 | 1330 | 28 |
| 6 | 806 | 55 | 1203 | 22 |
| 7 | 810 | 60 | 1213 | 20 |
| 8 | 571 | 68 | 847 | 28 |
| 9 | 551 | 73 | 822 | 32 |
| 10 | 547 | 74 | 824 | 31 |
| 11 | 549 | 79 | 815 | 31 |
| 12 | 509 | 79 | 758 | 31 |
| 13 | 530 | 76 | 798 | 31 |
| 14 | 552 | 78 | 819 | 33 |
| 15 | 518 | 79 | 778 | 33 |
| 16 | 595 | 75 | 785 | 30 |
| 17 | 550 | 78 | 830 | 31 |
| 18 | 519 | 74 | 774 | 32 |
| 19 | 523 | 78 | 838 | 31 |
| 20 | 491 | 74 | 733 | 30 |
| 21 | 518 | 70 | 769 | 30 |
| 22 | 874 | 62 | 1303 | 26 |
| 23 | 508 | 74 | 753 | 32 |
| 24 | 620 | 64 | 916 | 24 |
| 25 | 508 | 79 | 742 | 33 |
| 26 | 549 | 50 | 819 | 21 |
| 27 | 515 | 69 | 766 | 26 |
| 28 | 643 | 48 | 966 | 17 |
| 29 | 552 | 46 | 825 | 19 |
| 30 | 681 | 55 | 1011 | 19 |

As shown in Table 5, process (4) could increase the electrical conductivity of the metal materials, even though the strength of the metal material was slightly decreased compared to processes (1) to (3). Furthermore, process (5) could increase the strength of the metal materials, even though the electrical conductivity of the metal materials was slightly decreased. Furthermore, in the process (4) or (5), some example (the desirable example) tensile strength is 600 MPa over and electrical conductivity is more 40% IACS that it puts to all of material No. 1 to 30, as the process and 600 MPa over and electric conduction rate do not become or more IACS 40%, (1) to (3) of tension strength.

Meanwhile, the wires obtained in examples of the present invention, can be manufactured into twisted wires for wiring by twisting a plurality of the wires together. Seven wires of each of inventive example Nos. 1 to 30 shown in Tables 3 and 5 were twisted together to for twisted wires, but failure such as wire breaking did not occur in all the twisted wires.

### Example 2

A round rod (diameter of 20 mm) of the respective material of the example of the invention (Nos. 1, 14, 16, 28, 30) in Table 1, and the comparative example (Nos. 101 and 118) in Table 2 was cold-drawn (cold working) in accordance with the process (1) in the above described example 1, and subjected to the aging heat treatment to prepare a copper alloy wire (conductor wire) having a diameter of 0.17 mm. Seven wires thus prepared were twisted according to a conventional method, and then further compressed to prepare a twisted wire having a cross section of 0.13 mm². The twisted wire thus prepared was subjected to an aging heat treatment for 2 hours at a temperature of 450 degrees centigrade, and was further coated with an insulation material (polyethylene) to prepare an electrical wire for wiring (sample material).

The tensile strength (TS, unit: MPa) and the electrical conductivity (EC, unit: % IACS) were measured according to the above described method for the respective electrical wires thus prepared. Elongated length (EL, unit: %) for the stretch was measured at the same time when the tensile strength was measured. The results of the measured properties of the sample materials are shown in Table 6.

### [Table 6]

TABLE 6

| No. | TS | EC | EL |
|---|---|---|---|
| 1 | 432 | 73 | 9 |
| 14 | 466 | 75 | 8 |
| 16 | 505 | 73 | 6 |
| 28 | 571 | 48 | 12 |
| 30 | 624 | 54 | 10 |
| 101 | 292 | 74 | 12 |
| 118 | 701 | 37 | 5 |

As shown in Table 6, all of the sample materials prepared with the use of the respective materials show more than 5% of elongation, which means that the sample material can be applied to the use in which the material is allowed to be stretched by the inflicted shock load. However, the sample material prepared with the use of the material Nos. 101, 118, which are comparative examples with an alloy compositon out of the scope or preferable scope of the invention, show a low tensile strength (TS) of below 400 MPa, or a low electrical conductivity of below 40% IACS. Thus, it has been found that those sample material is not preferably used for an electrical wire for wiring.

### INDUSTRIAL AVAILABILITY

A conductor wire for electronic apparatus of the invention can be suitably used for a general wire used for the conductor wire for electronic apparatus. In particular, the conductor wire can be suitably used for automobile wiring or robot wiring or the like. Furthermore, the conductor wire can be suitably used for a conductor wire for electronic apparatus used after pressing the terminal thereof for connection.

An electronic wire for wiring using the conductor wire for electronic apparatus of the invention can be suitably used for an electrical wire for wiring.

The invention is described together with various exemplary embodiments. However, the invention is not limited to any detail of the embodiments, unless clearly pointed out. The scope of the present invention is to be considered wide along the concept and the scope of the invention.

This application claims priority from Japanese Patent Application No. 2007-285585 filed in Japan on Nov. 1, 2007, the disclosures of which are incorporated as a part of the specification by reference herein.

1-6. (canceled)

7. A conductor wire for electric apparatus composed of a copper alloy which contains 0.5-3.0 mass percent of cobalt, 0.1-1.0 mass percent of silicon, and the balance being copper and inevitable impurities.

8. The conductor wire for electric apparatus as set forth in claim 7, wherein the copper alloy further contains 0.1-3.0 mass percent of nickel.

9. The conductor wire for electric apparatus as set forth in claim 7, wherein the copper alloy further contains the sum total of 0.05-1.0 mass percent of one or two or more elements selected from the group consisting of iron, silver, chromium, zirconium and titanium.

10. The conductor wire for electric apparatus as set forth in claim 8, wherein the copper alloy further contains the sum total of 0.05-1.0 mass percent of one or two or more elements selected from the group consisting of iron, silver, chromium, zirconium and titanium.

11. The conductor wire for electric apparatus as set forth in claim 7, wherein the copper alloy further contains the sum total of 0.01-3.0 mass percent of one or two or more selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

12. The conductor wire for electric apparatus as set forth in claim 8, wherein the copper alloy further contains the sum total of 0.01-3.0 mass percent of one or two or more selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

13. The conductor wire for electric apparatus as set forth in claim 9, wherein the copper alloy further contains the sum total of 0.01-3.0 mass percent of one or two or more selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

14. The conductor wire for electric apparatus as set forth in claim 10, wherein the copper alloy further contains the sum total of 0.01-3.0 mass percent of one or two or more selected from the group consisting of 0.05-0.5 mass percent of magnesium, 0.1-2.5 mass percent of zinc, 0.1-2.0 mass percent of tin, 0.01-0.5 mass percent of manganese and 0.01-0.5 mass percent of aluminum.

15. The conductor wire for electric apparatus as set forth in claim 7, wherein the total cold-working ratio before and after aging heat treatment is more than 99%.

16. The conductor wire for electric apparatus as set forth in claim 8, wherein the total cold-working ratio before and after aging heat treatment is more than 99%.

17. The conductor wire for electric apparatus as set forth in claim 9, wherein the total cold-working ratio before and after aging heat treatment is more than 99%.

18. The conductor wire for electric apparatus as set forth in claim 10, wherein the total cold-working ratio before and after aging heat treatment is more than 99%.

19. The conductor wire for electric apparatus as set forth in claim 11, wherein the total cold-working ratio before and after aging heat treatment is more than 99%.

20. The conductor wire for electric apparatus as set forth in claim 12, wherein the total cold-working ratio before and after aging heat treatment is more than 99%.

21. The conductor wire for electric apparatus as set forth in claim 13, wherein the total cold-working ratio before and after aging heat treatment is more than 99%.

22. The conductor wire for electric apparatus as set forth in claim 14, wherein the total cold-working ratio before and after aging heat treatment is more than 99%.

23. An electrical wire for wiring composed of a plurality of conductor wires for electronic apparatus as set forth in any one of claims 7 to 22, the conductor wires being twisted together.
